(19) United States
(12) Patent Application Publication
(10) Pub. No.: US 2019/0112898 A1
(43) Pub. Date: Apr. 18, 2019

(54) METHOD FOR DETERMINING FILTRATION PARAMETERS IN MULTI-WELL SYSTEM VIA PULSE-CODE OBSERVATION WELL TESTING METHOD

(71) Applicant: LIMITED LIABILITY COMPANY "POLIKOD", Kazan (RU)

(72) Inventors: Rushaniya Rinatovna FARAKHOVA, der. Starye Enali (RU); Georgiy Valentinovich VASIL'EV, Kazan (RU)

(73) Assignee: LIMITED LIABILITY COMPANY "POLIKOD", Kazan (RU)

(21) Appl. No.: 16/086,010

(22) PCT Filed: Jul. 12, 2016
(86) PCT No.: PCT/RU2016/000430

§ 371 Date: Sep. 18, 2018

(51) Int. Cl. E21B 41/00; G01V 1/42; G01V 1/28

(52) U.S. Cl. CPC E21B 41/0092; E21B 49/00; G01V 1/282; G01V 1/42

(57) ABSTRACT

The pressure Pulse-Code Testing (PCT) is a complex solution to the inter-well interference problem and claims to significantly expand the applicability of a traditional interference test in practice. The present invention relates to oil production technologies, namely methods for conducting, interpreting and analyzing the results of hydrodynamic tests in the area of each well. A three-dimensional hydrodynamic model is formed, then the PCT is modeled, then an optimal test design is selected, then a fishery test is carried out in the above scenario and reservoir filtration parameters are determined by interpreting the data, ultimately updating the hydrodynamic model taking into account the data determined in the previous step.

This application is the U.S. national phase of International Application No. PCT/RU2016/000430 filed Jul. 12, 2016, which designated the U.S., and the entire content of which is hereby incorporated by reference.

### FIELD OF TECHNOLOGY

The instant invention relates to oil production technologies, namely to the methods of interpretation and analysis of pressure well test's results in zone of each well in multi-well system.

### BACKGROUND OF THE INVENTION

Interference Well Test—is performed for the purpose of qualitative assessment of reservoir permeability, estimation of well interference, detection of impermeable boundaries in the reservoir, etc. This test is long and resource intensive; therefore, it requires careful design in order to reduce the risks of obtaining poor-quality information.

The disadvantage of traditional Interference Well Test is to carry out only a single wave of pressure changing in the reservoir. This approach increases the error in determining reservoir properties due to a lack of additional information. For example, the impact of the work of surrounding wells, which will be difficult to filter off the impulse of the well-generator of pressure changes.

Well measurements are the most laborious and costly part of the field test. At the same time, it is not always possible to solve the tasks for a number of reasons: there is no quality design (planning) research in the field, there are technical difficulties as in research and in the interpretation of the received data, no competent persons to interpret the total volume of the data. Among known methods in the field there are the following.

RU 2400622 [symbol] ]A method for determining the filtration properties of the bottomhole formation zone by the method of high-frequency filtration pressure waves”, published on Oct. 2, 2010.

Pressure well tests were carried out; periodic changes of pressure in the investigated formation was carried out by periodic change of production rate. Full cycle of single well studies consists of studies on a number of periods of hydrodynamic effects, for example, 20 s, 40 s, 1 min, 5 min, 20 min, 40 min, starting from the lowest period value, first covering the closest zone to the well, Large values of exposure periods. For each period value at least 5 oscillations were excited and recorded. Pressure recording is performed both at the wellhead and at the bottom of the well.

The main disadvantage of the described invention is that only an analytical method of interpreting the obtained data is considered, which is not enough and does not allow for a detailed analysis of the reservoir properties at the area of each well. Also there are special requirements to the number of periods, their frequencies.

RU 2476669 “Method for determination of reservoir parameters”, published on Feb. 27, 2013, the patent holder is LLC “Gazpromneft NTC”.

A method for determination of reservoir filtration characteristics that includes a long-term monitoring of the bottom-hole pressure and flow rate changes over time, starting from the moment the well is brought into production, characterized in that after a continuous well operation cycle of at least 30 days, a long, no less than 3 days, recovery curve is registered basing on which current productivity of the reservoir is evaluated. Then, the pressure and flow rate curves are reinterpreted during the entire observation period from the start of the well and, based on a comparison of the current productivity with the initial one, it is determined how much the skin factor has changed. A disadvantage of the described method is being unable to separate well interference from reservoir boundaries. The other limitation is the selection of the tested well, as well just started to produce. It is usually a hydraulically fractured well and the hydraulic fracturing method could be unpredictable and unprofitable from the economic point of view in case of water formation nearby. Hydraulic fracturing of the formation results in the appearance in the well water of many impurities harmful to humans, including benzene, toluene, ethylbenzene and dimethyl benzenes, in other words, it is a less secure way.

RU 2166069 “Method of developing oil fields in waterflooding conditions,” published on Apr. 28, 2000, the patent holders Ovchinnikov M N, Kushtanova G. G.

The invention relates to the oil industry and is intended for the development of oil fields in waterflood conditions. It provides expansion of application areas for non-stationary methods of oilfield development and additional oil extraction from localized areas. The character of the invention: a multiphase liquid is withdrawn by the method from producing wells. A working agent is pumped into the injection wells. Hydrodynamic regimes are created through the startup and shutdown of the injection and production wells. Transmissibility and diffusivity of the reservoir are determined. For impulse actions, generator-wells are selected in the water-flooded and oil zone. The components of the field of transmissibility along the displacing and oil phases are determined for different periods according to the given dependence.

A disadvantage of the described method is the need to periodically stop injection and production wells, which leads to production deferment. The determination of filtration properties by this method is possible only if there is no free gas in the reservoir.

### THE TASK SOLVED BY THE CREATED TECHNICAL SOLUTION

The main idea of the pressure Pulse-Code Testing (PCT) is the generation of complex codes in generator wells by changing well flow rate and/or injection rate. The created pressure changes in the formation are detected in the receiver wells. If amplitude of pressure variation above the pressure gauge sensitivity, then they can be decoded by advance mathematical algorithms. With PCT it is possible to perform simultaneous test of entire groups of wells by using specifying codes of any complexity without production deferment.

According to the results of the PCT are determined reservoir parameters:

1. Primary:
transmissibility for zone of each well and interval between wells
pressure diffusivity for each well and interval between wells
skin-factor for generator wells

2. Secondary (two of the following formation properties between the wells to choose from):
dynamic permeability
porosity
connected net formation thickness
dynamic compressibility
water saturation
fracture parameters

### SUMMARY OF THE INVENTION

The present invention is eliminating the disadvantages of existing solutions.

pressure Pulse-Code Testing (PCT) is the modern development of cross-well pressure interference testing, bused on bottom-hole pressure response in one well to the rate variation in another well.

Unlike traditional interference test which is based on step-response analysis while responding well and surrounding wells are shut-in the PCT procedure assigns a generating well to change flow rate in a certain pre-calculated sequence and does not require shutting down other wells. This creates coded pressure pulsations propagating throughout the formation which are captured by downhole gauges and decoded at surface.

This allows conducting the cross-well scanning in the group of highly interfering wells without production deferment.

Although the survey's period of each interval is relatively long (weeks or even months), due to ability of parallel scanning of all intervals, the overall duration of the test of the whole group remains not too long and quite acceptable. Modern high-precision pressure/temperature gauges, modern methods of mathematical processing and multi-core computing allow scanning entire areas and even entire deposits with a quantitative interpretation of results, even on low-permeability or high viscosity layers.

An obligatory element in the field development is the implementation of a complex of tests that, according to the results of the interpretation, reservoir engineer “must” solve a number of problems: assess the current water saturation between wells, create and maintain a permanent 3D model of the field, on base of which determine optimal production/injection pressures and give recommendations for the process of further development of the field.

The determination of reservoir filtration properties in a multi-well system by the PCT method is implemented, according to the invention, by performing the following steps:

Sector model of the tested area

Multi-well PCT design

Selection of the optimal test scenario (period time and generator rate)

Carrying out the PCT in the oilfield

Reading pressure data from pressure gauges in the receivers

Determining reservoir properties for each tested well

Updating the initial 3D hydrodynamic model taking into account the data defined in the previous step.

Advantages of the invention are:
No need to stop producing wells, unlike other similar technologies,
Formation transmissibility and diffusivity independent determination.

In implementing the invention, the hydrodynamic model includes the properties of reservoir and reservoir fluid which influencing the pressure pulses propagation.

When implementing the invention, optimal generator and receiver wells are defined in the hydrodynamic model.

When implementing the invention, critical zones are defined in the formation, in which it is not recommended to perform the test.

When implementing the invention, the sensitivity and characteristics of pressure gauge are taken into account while planning the test.

When implementing the invention, in PCT design, model pressure response for receiver wells is calculated.

When implementing the invention, optimal period of producing/injecting rates and time are determined.

When implementing the invention, in modeling scenarios, the criterion for choosing the optimal scenario is the distance between the wells, the current productivity of the wells and the properties of the near wellbore zone.

In implementing the invention, information on the dynamic permeability of reservoir, anisotropy in permeability and possible barriers in reservoir are added to the initial hydrodynamic model.

In the implementation of the invention, an updated hydrodynamic model is analyzed, clarifying the presence of faults between the wells and/or clarifying the locations of formation pinch-out and/or adjusting the development plan of the reservoir at the tested area based on the results of the tests.

### BRIEF DESCRIPTION OF THE FIGURES

The procedure of the PCT method is shown in the following figures:

FIG. 1—Curves of pressure and rate changes in the generator well

FIG. 2 —Pressure changes at receiver wells, sensitivity analysis to generator well flow rate changes

FIG. 3—Modification of modes at the generator well

FIG. 4—PCT plan for field operation

FIG. 5—Determination of reservoir filtration parameters.

### DETAILED DESCRIPTION OF THE INVENTION

Below, the concepts and definitions necessary for the detailed description of the current invention will be described.

The rock that makes the reservoir possesses specific properties that characterized its ability to contain and give liquids: porosity and permeability.

Porosity is the ratio of the pore volume to the total volume of the rock:

$$m = \frac{{V}_{pore}}{V}$$

Permeability characterized the ability of the rock to pass fluids through its pores. In the simplest model of filtration—the classical model of the elastic drive of Shchelkachev—the fluid filtration rate is directly proportional to the pressure gradient and inversely proportional to the viscosity of the fluid (Darcy's law):

$$w ( r , t ) = \frac{k}{μ} ∇ p ( r , t ) ,$$

where w (r, t) is the fluid filtration rate, μ is the dynamic viscosity of the fluid, p (r, t) is the pressure.

Oil reservoir, composed of rocks (possessing reservoir properties) saturated with fluids, with certain thickness, limited by impermeable interlayers, has its own macroscopic parameters: diffusivity and transmissibility. It is these properties that are determined during the PCT.

Formation diffusivity characterizes the ability of the layer to transmit pressure and depends on the permeability, fluid viscosity and total compressibility:

$$χ = \frac{< \frac{k}{μ} >}{Φ \cdot ( c + {c}_{r} )}$$

where k—permeability, μ—viscosity, Φ—porosity, c—fluid compressibility, cᵣ—rock compressibility

c=cₒ·Sₒ+c_{w}·S_{w}+c_{g}·S_{g}

where cₒ—oil compressibility, Sₒ—oil saturation, c_{w}—water compressibility, S_{w}—water saturation, c_{g}—gas compressibility, S_{g}—gas saturation

Formation transmissibility characterizes the ability of the reservoir to pass a fluid, and is related to the permeability of the rock and the viscosity of the fluid by the formula:

$$σ = < \frac{k}{μ} > \cdot h$$

where k—permeability, μ—viscosity, h—net formation thickness

$$< \frac{k}{μ} >= {k}_{abs} [ \frac{{k}_{ro} ( {S}_{w} , {S}_{g} )}{{μ}_{o}} + \frac{{k}_{rw} ( {S}_{w} , {S}_{g} )}{{μ}_{w}} + \frac{{k}_{rg} ( {S}_{w} , {S}_{g} )}{{μ}_{g}} ]$$

where k—permeability, k_{abs}—absolute permeability, μ—viscosity, μₒ—oil viscosity, μ_{w}—water viscosity, μ_{g}—gas viscosity, kᵣₒ—oil relative permeability, k_{rw}—water relative permeability, k_{rg}—gas relative permeability, S_{w}—water saturation, S_{g}—gas saturation

Interval between wells is the pore space between the wells, which has such properties as permeability, porosity, saturation, etc. It is a significant gap in the test technology by standard interpretation methods. The parameters of the interval between wells are necessary for the correct description of the filtration flows in the drained reservoir.

Interference tests using the PCT method are performed to reveal interference between wells, to determine reservoir properties in the zone between wells: anisotropy of horizontal permeability, net formation thickness, oil saturation, rock compressibility, and location of impermeable boundaries.

Geoinformation database is a system for collecting, storing, analyzing and graphically visualizing areal data and associated information about the required objects.

2D or 3D model, which include reservoir properties (basis of available data: core, well logs, historical well testes, production history) is assembled to model the PCT:

Determined and Specified:

reservoir properties (reservoir pressure, porosity, rock compressibility, net formation thickness distribution in the zone of each well, permeability) capable of influencing the propagation of the pressure pulse along the investigated section of the reservoir.

properties of reservoir fluid (saturation/water cut, fluid density, viscosity, volume coefficients), which can influence the propagation of the pressure pulse along the investigated section of the reservoir.

selected generator/receiver wells, the number of pulses, period time, duration, flow rate of generator well.

the duration of pulses is determined from the condition of a noticeable change in the bottomhole pressure at the receiver wells in comparison with the initial reservoir pressure, taking into account the gauge sensitivity, as well as the effect of noise in the formation.

A zone is defined in which it is not recommended to change the well drawdowns, perform well tests during the pulses creation. For this, a distance equal to the investigation radius is calculated for the proposed properties of reservoir zone of pressure pulse code test survey.

Based on gauge characteristics (measurement range, sensitivity, error, operating conditions, discreteness of measurements, memory size, time of continuous operation, dimensions) and the constraints imposed by the situation, a model is formed.

Modeling the PCT.

PCT technology consists of creating a series of pressure changes (impulses) in the generator wells by changing its flow rates.

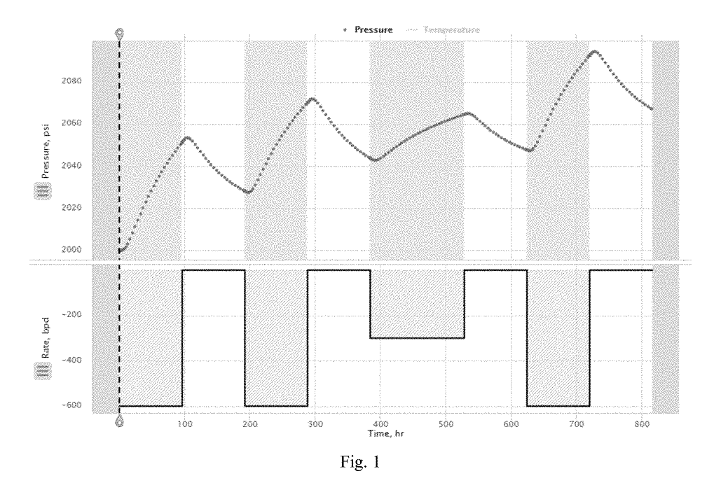

There are several the periods of production (or injection). Changes in the pressure caused by pulses are measured in the receiver wells (FIG. 1).

When varying the flow rate of generator wells, production periods (or injection), well modes (injection, production, shut in), it is possible to obtain test design that have different amplitudes of generator pulses.

And although the test duration of each interval is long (weeks or months), due to the parallel scanning of all intervals, the total duration of the test for the entire group remains the same, and is quite acceptable.

Thus, the PCT is one of the types of interference test and, like classical interference test, it basically allows the numerical values of such reservoir filtration properties as transmissibility, diffusivity and skin-factor.

The key difference of PCT technology is that due to modern high-precision gauges, modern methods of mathematical processing and multi-core computer technology, it is possible to obtain high noise immunity of the method and to stably calculate these parameters, which in practice makes it possible to scan large areas and even entire deposits with a quantitative interpretation of the results, even on low-permeability reservoir.

Choosing the Optimal Test Scenario.

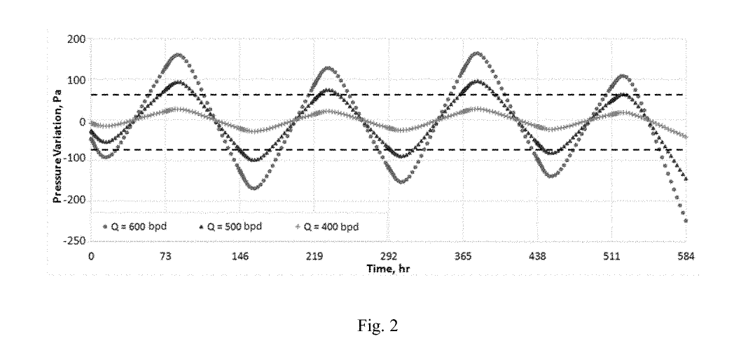

Optimal modes of investigation are chosen based on the analysis of the amplitude of pressure response. Duration of the pressure pulses is determined from the condition of a noticeable change in the bottom-hole pressure in the receiver wells as compared to the initial reservoir pressure. It is necessary to take into account the sensitivity of the gauge, as well as the effect of noise in the formation. To do this, a sensitivity analysis is carried out, which includes: sensitivity analysis of the reservoir, sensitivity analysis of the three-dimensional model, sensitivity analysis of the gauges. The sensitivity of the reservoir is analyzed from the history of generator-wells. For a given injectivity, repression on the formation may vary within certain limits, which entails a certain pressure variation in the reacting wells. In the analysis of the hydrodynamic model, various steps in time and over the grid are set, and the range of pressure changes is verified (FIG. 2). Analyzing the gauge sensitivity, take into account its error. The reservoir parameters (porosity, permeability), liquid properties (volumetric coefficient, saturation pressure, viscosity, gas content, density, compressibility) are estimated.

The present invention allows the use of several generator wells and several receiver wells. Generator wells continue to operate at a constant production rate, which avoids the loss of oil production. Receivers also do not lose in the total volume, due to compensation of injection (production)

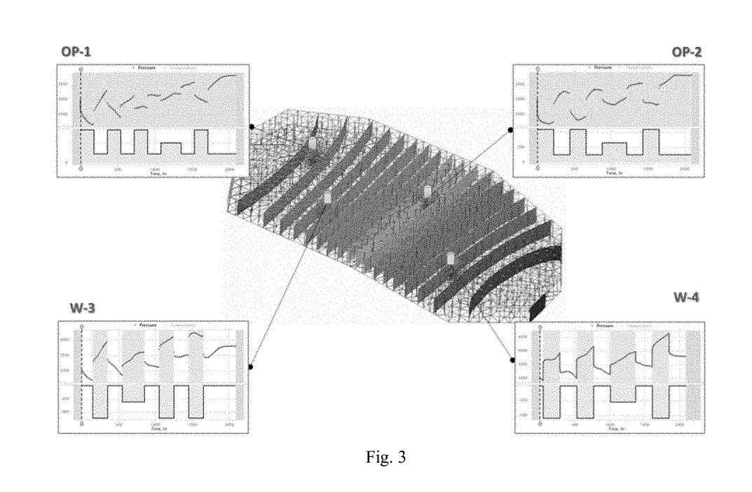

The present invention allows the use of several generators and several receivers. To separate responses from generators, set a “notch” in the generator-wells by decreasing the injection (production) and increasing its duration on any impulse (for each well at different periods) (FIG. 3).

The test is conducted in the production field according to the scenario mentioned above;

Based on the model calculations, a field plan for carrying out the impulse action is designed.

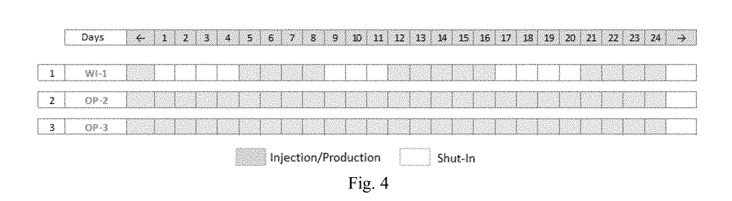

The predictable plots of the bottom hole pressure behavior in the generators and receivers are presented. PCT is conducted according to the approved test schedule (FIG. 4). However, deviating the test from the scenario for technical reasons in the oilfield conditions still allows achieving the effect.

The reservoir properties of the data are determined with the help of the interpretation of the data obtained during the execution of the test mentioned above;

Due to significant attenuation, the amplitude of the oscillations in the reacting wells may be small, not always visible against the backdrop of accidental noise and drift of reservoir pressure. In this case, an advanced processing method is used for signal analysis: pulse-code detrending (PCD).

PCD is an algorithm for subtracting the trend and isolating the “useful signal”. This algorithm is mainly used in interpreting the data of the PCT survey when there are disturbances from other operating wells in the reacting well.

When selecting a trend, the main data does not change, so you can repeat the operations of building a trend with different parameters and different methods. After obtaining the necessary curve, you need to record the trend.

The signs of the correct trend: the maxima and minima of different periods of waves are approximately on the same level or, for different amplitude of oscillations, are symmetric with respect to the midline, the maxima and minima are approximately the same with respect to the period boundaries.

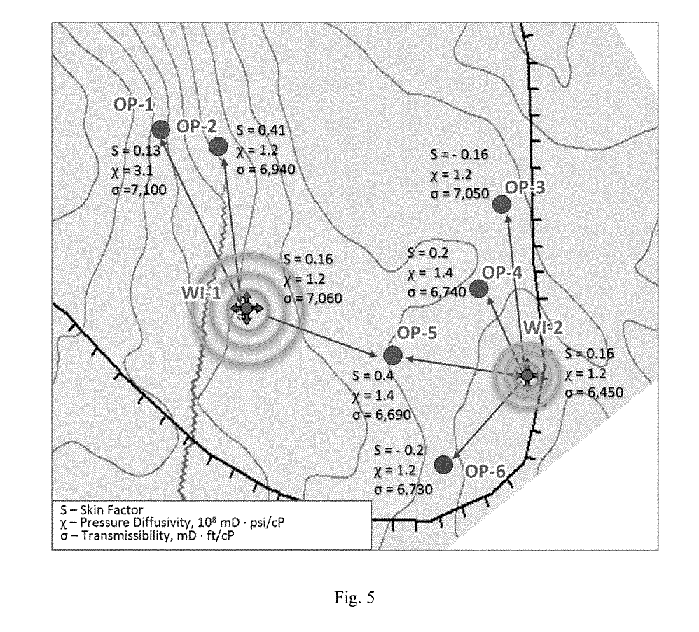

The obtained pressure data is used to determine the values of the transmissibility, diffusivity, and skin-factor in the zone of each well (FIG. 5). Then, an update of the hydrodynamic model is used taking into account the data defined in the previous step; based on PCT results and the actual results obtained, the hydrodynamic model is calibrated according to the new data. Based on the results of the variation amplitude, a conclusion is made about the presence of fault faults and the boundary of the front of the injected water.

The foregoing describes the invention with embodiment examples of the invention considered to be currently preferred, but for those skilled in the art is obvious that numerous changes and additions can be made thereto. Accordingly, it is intended that the invention is not limited to a particular embodiment thereof and should be interpreted within the scope of the rights defined by the claims.

Following the results of the PCT a decision is issued on:
1. Primary Parameters:
   transmissibility for zone of each well and interval between wells
   pressure diffusivity for each well and interval between wells
   skin-factor for generator wells
2. Secondary (two of the following formation properties between the wells to choose from):
   dynamic permeability
   porosity
   connected net formation thickness
   dynamic compressibility
   water saturation
   fracture parameters
PCT Advanced mathematical methodology makes it possible to extend to
   multi-well zone with operating (production/injection) wells
   reservoir zone, with suspicion of unidentified communications, including communications in the inter-wellbore interval
   low-permeability oil reservoirs
   high-viscosity fluids
   gas and gas condensate fields
   underground gas storages
   zones where PCT is limited in time (sea platforms and other hard-to-reach places).

1. A method for determining reservoir filtration properties in a multi-well system using pressure Pulse-Code Testing, comprising the following steps:
forming a 3D hydrodynamic model;
modeling the pressure Pulse-Code Testing design for job schedule;
selecting the optimal scenario of the test performing;
investigating an oilfield by the selected scenario and determining reservoir filtration properties and well properties, such as: transmissibility, pressure diffusivity, skin-factor, by interpreting the data obtained during the PCT;
updating the hydrodynamic model by taking into account the data determined in the previous step.

2. The method of claim 1, wherein the hydrodynamic model includes reservoir properties, capable of influencing the propagation of the pressure pulse.

3. The method of claim 1, wherein the hydrodynamic model includes reservoir fluid parameters capable of influencing the propagation of the pressure pulse.

4. The method of claim 1, wherein the generator and receiver wells are defined in the hydrodynamic model.

5. The method of claim 1, wherein during formation of the model a critical zone is defined in which it is forbidden to conduct a well test.

6. The method of claim 1, wherein necessary gauge characteristics are determined based on the simulation results and constraints.

7. The method of claim 1, wherein a predictive response on receiver wells is calculated during modeling of well operating scenarios.

8. The method of claim 1, wherein duration of the work period and the operating pressures of the production and injection wells are determined during modeling of well operating scenarios.

9. The method of claim 1, wherein during modeling of well working scenarios the criteria for choosing the optimal operating pressures and test duration are distance between the wells, current well productivity and properties in the area of each well.

10. The method of claim 1, wherein information on the dynamic permeability of reservoir, anisotropy in permeability and possible barriers in reservoir is added to the updated 3D hydrodynamic model.

11. The method of claim 1, wherein the updated hydrodynamic model is analyzed by specifying the presence of fault fractures between the wells or by refining the locations of the formation of seepage zones or by adjusting the development plan based on the results of the tests.
